(19) United States
(12) Patent Application Publication
(10) Pub. No.: US 2013/0177304 A1
(43) Pub. Date: Jul. 11, 2013

(54) PORTABLE ELECTRONIC DEVICE CASE ACCESSORY WITH INTERCHANGEABLE CAMERA LENS SYSTEM

(71) Applicant: TARGUS GROUP INTERNATIONAL, INC., Anaheim, CA (US)

(72) Inventors: Melissa Waters Chapman, Manhattan Beach, CA (US); Jacques Phillip Langlois, Los Angeles, CA (US); Mark Andrew Thoni, Rancho Santa Margarita, CA (US)

(73) Assignee: TARGUS GROUP INTERNATIONAL, INC., Anaheim, CA (US)

(21) Appl. No.: 13/739,846

(22) Filed: Jan. 11, 2013

Related U.S. Application Data
(60) Provisional application No. 61/585,543, filed on Jan. 11, 2012.

(51) Int. Cl. G03B 17/56

(52) U.S. Cl. CPC G03B 17/565
USPC 396/533; 396/529

(57) ABSTRACT

An accessory case for a portable electronic device (PED) includes an interchangeable camera lens system comprising one or more camera lenses. The accessory case may include an integrated attachment mechanism allowing the one or more lenses to be secured to the case in a certain position relative to the image capturing system. In certain embodiments, the one or more camera lenses may alter and/or improve the performance of an image capturing system of the PED. The one or more camera lenses may include a telephoto lens, a macroscopic lens, a fish-eye lens, a wide angle lens, and/or any other type of optical system. In some embodiments, the one or more camera lenses may be removably attached to the accessory case. In further embodiments, the one or more camera lenses may be included in a selectively positionable mechanism integrated into the accessory case.

### RELATED APPLICATIONS

This application claims priority under 35 U.S.C. 119(e) to the U.S. provisional application No. 61/585,543, titled “Portable Electronic Device Case Accessory with Lens Feature”, filed on Jan. 11, 2012. The entire contents of provisional application No. 61/585,543 are herein incorporated by reference.

### TECHNICAL FIELD

The present disclosure relates generally to portable electronic devices and, more specifically, to a case accessory for a portable electronic device that includes one or more camera lenses.

### SUMMARY OF THE INVENTION

Disclosed herein are embodiments of an case accessory for a portable electronic device (PED) that includes an interchangeable camera lens system comprising one or more camera lenses. The case accessory may include an integrated attachment mechanism allowing the one or more lenses to be secured to the case in a certain position relative to the image capturing system. In certain embodiments, the one or more camera lenses may alter and/or improve the performance of an image capturing system of the PED. The one or more camera lenses may include a telephoto lens, a macroscopic lens, a fish-eye lens, a wide angle lens, and/or any other type of optical system. In some embodiments, the one or more camera lenses may be removably attached to the case accessory. In further embodiments, the one or more camera lenses may be included in a selectively positionable mechanism integrated into the case accessory.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A illustrates a back view of a case accessory for a portable electronic device that includes an interchangeable camera lens system utilizing a compression fit mechanism consistent with embodiments of the present disclosure.

FIG. 1B illustrates a cross-sectional side view of a case accessory for a portable electronic device that includes an interchangeable camera lens system utilizing a compression fit mechanism consistent with embodiments of the present disclosure.

FIG. 2A illustrates a back view of a case accessory for a portable electronic device that includes an interchangeable camera lens system utilizing a threaded mechanism consistent with embodiments of the present disclosure.

FIG. 2B illustrates a cross-sectional side view of a case accessory for a portable electronic device that includes an interchangeable camera lens system utilizing a threaded mechanism consistent with embodiments of the present disclosure.

FIG. 3A illustrates a back view of a case accessory for a portable electronic device that includes an interchangeable camera lens system utilizing a bayonet mechanism consistent with embodiments of the present disclosure.

FIG. 3B illustrates a cross-sectional side view of a case accessory for a portable electronic device that includes an interchangeable camera lens system utilizing a bayonet mechanism consistent with embodiments of the present disclosure.

FIG. 4A illustrates a back view of a case accessory for a portable electronic device that includes an interchangeable camera lens system utilizing a magnetic mount consistent with embodiments of the present disclosure.

FIG. 4B illustrates a cross-sectional side view of a case accessory for a portable electronic device that includes an interchangeable camera lens system utilizing a magnetic mount consistent with embodiments of the present disclosure.

FIG. 4C illustrates a back view of the case accessory of FIG. 4A consistent with one embodiment of the present disclosure.

FIG. 4D illustrates a back view of the case accessory of FIG. 4A consistent with another embodiment of the present disclosure.

FIG. 4E illustrates a back view of the case accessory of FIG. 4A consistent with yet another embodiment of the present disclosure.

FIG. 5A illustrates a back view of a case accessory for a portable electronic device that includes an interchangeable camera lens system utilizing a sliding mechanism consistent with embodiments of the present disclosure.

FIG. 5B illustrates a cross-sectional side view of a case accessory for a portable electronic device that includes an interchangeable camera lens system utilizing a sliding mechanism consistent with embodiments of the present disclosure.

FIG. 6A illustrates a back view of a case accessory for a portable electronic device that includes an interchangeable camera lens system utilizing a rotating mechanism consistent with embodiments of the present disclosure.

FIG. 6B illustrates a cross-sectional side view of a case accessory for a portable electronic device that includes an interchangeable camera lens system utilizing a rotating mechanism consistent with embodiments of the present disclosure.

### DETAILED DESCRIPTION OF PREFERRED EMBODIMENTS

The proliferation of portable electronic devices (PEDs), including notebook and tablet computers (e.g., the Apple® iPad™), portable digital assistants (PDAs), and smartphones, has placed more computing power into the hands of users than the computing power of early computers that occupied an entire room. This portable computing power has enhanced both personal and business mobile productivity. With their increasing computing power, PEDs now often include image capturing systems (e.g., digital cameras and/or flash systems) for capturing and storing fixed or moving images. Due to the portability of their host PEDs, however, such image capturing systems are often rudimentary and have limited imaging capabilities. For example, conventional PED image capturing systems often include fixed optical components (e.g., lenses).

Embodiments of the present disclosure provide an accessory case for a PED that includes one or more camera lenses. In some embodiments the accessory case may include an interchangeable camera lens system. In some such embodiments, the accessory case may include an integrated attachment mechanism allowing one or more accessory lenses to be secured to the case in a certain position relative to the image capturing system. In certain embodiments, the one or more accessory lenses may alter and/or improve the performance of the PED image capturing system. For example, the one or more accessory lenses may include a telephoto lens, a macroscopic lens, a fish-eye lens, a wide angle lens, and/or any other type of optical system. In some embodiments, the one or more accessory lenses may be removably attached to the accessory case. In further embodiments, the one or more accessory lenses may be included in a selectively positionable mechanism integrated into the accessory case.

Embodiments may be best understood by reference to the drawings. It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In some cases, well-known structures, materials, or operations are not shown or described in detail.

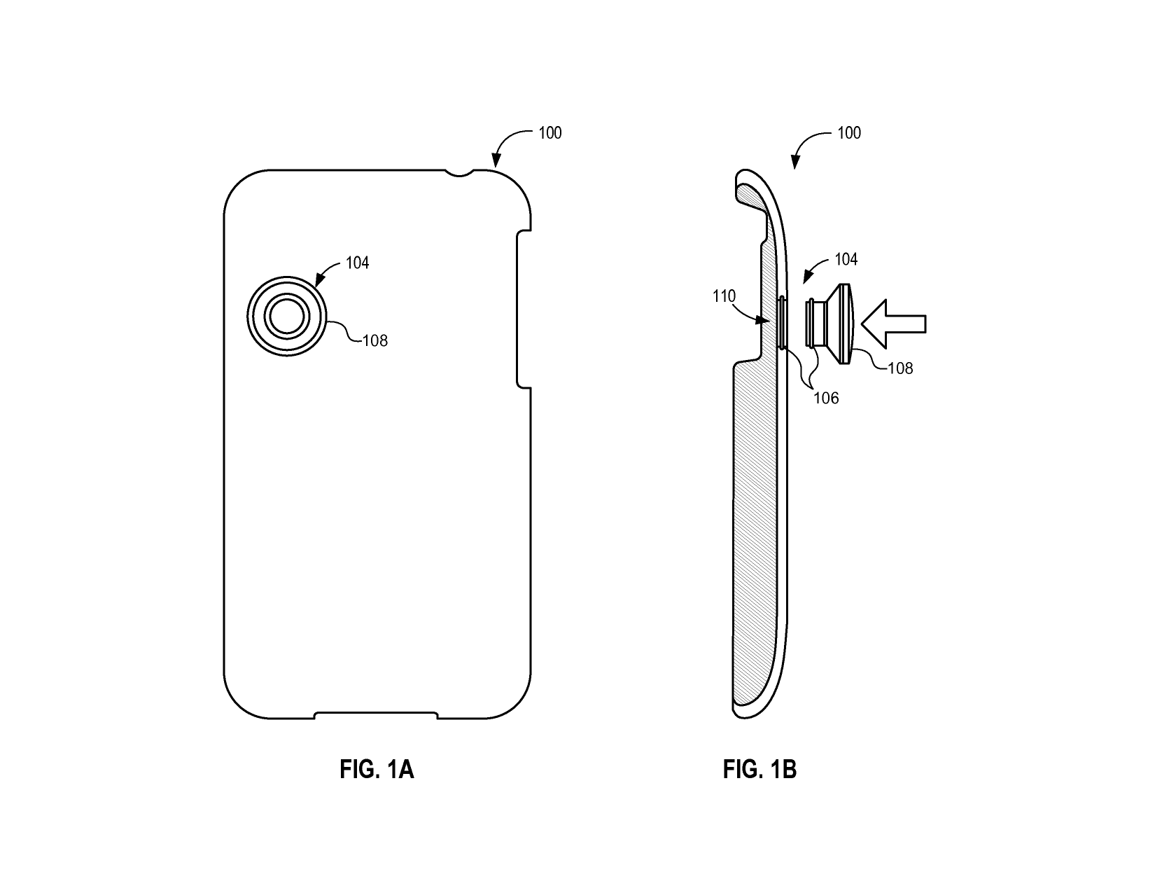

FIG. 1A and FIG. 1B respectively illustrate a back and cross-sectional side view of a case accessory 100 for a PED that includes an interchangeable camera lens system 104 utilizing an attachment mechanism 106 consistent with embodiments of the present disclosure. The illustrated case 100 may be referred to as a stand, holder, sleeve, mount, or the like and, as used herein, does not necessarily imply an encasing or retaining functionality, although some embodiments of the case 100 may have such functionalities. The PED may be any portable electronic device including, for example, a notebook computer, an electronic book reader (e.g., the Amazon® Kindle™), a smartphone (e.g., the Apple® iPhone™, the Motorola® Droid®, and the BlackBerry® Storm™), and/or a tablet computer (e.g., the Apple® iPad™, the HP® Slate, and the Samsung® Galaxy™ Tablet). In the illustrated embodiment, the PED is an Apple® iPhone™.

The case 100 can be configured to receive a PED, and may further function to retain, carry, and/or protect the PED. The PED may include on the front and/or back face of the PED a display viewable in either a portrait orientation or a landscape orientation, a user input, and a data input/output port. In some embodiments, the case 100 may be configured such that the display, user input, and data input/output port are accessible by a user of the PED while the PED is disposed in the case 100. Further, in some embodiments, the case 100 may include a protective screen disposed over the display.

In certain embodiments, the case 100 is configured to grip or otherwise secure the PED. For example, the case 100 may comprise a resilient material that can selectively expand so as to receive the PED through a front opening and resiliently close about an outer edge of the PED. The case 100 may also be configured to substantially cover the entirety of a back face of the PED. In some embodiments, the case 100 may comprise a rubber or other elastomeric material (e.g., silicone) configured to provide a secure friction fit around the perimeter of the PED to secure the case 100 around the PED. The case 100 may also comprise rigid materials (e.g., plastic, metal, and the like) and include a rigid frame. In some embodiments, the case 100 may comprise releasable clips, straps, or other locking features that allow for the PED to be selectively locked into the case 100 and selectively released from the case 100.

The PED may include an integrated image capturing system that may comprise a camera and/or flash system. The image capturing system may also include additional hardware and/or software components internal to the PED and used to enable the functionality of the image capturing system. In certain embodiments, the camera and/or flash systems may be disposed on the back face of the PED. In some embodiments, a PED may also include one or more image capturing systems disposed on other faces and/or sides of the PED (e.g., the front face and/or the front and back faces of the PED).

In certain embodiments, the case 100 may define at least one opening 110 that exposes an image capturing system included on the PED when the PED is disposed in the case 100. For example, as illustrated, the case 100 may define an opening 110 configured to allow use of a camera and/or flash system integrated into a PED when the PED is disposed in the case 100. In some embodiments, the case 100 may define one opening 110 for the use of the camera system and an additional opening 110 for the use of the flash system. In some embodiments, the opening 110 may be covered by a selectively positionable protective cover (not shown) configured to protect the image capturing system of the PED when the image capturing system is not in use.

An integrated image capturing system of the PED may have certain limited image capturing capabilities attributable to fixed optical components. For example, the PED image capturing system may include a fixed lens system configured to operate reasonably well in a wide variety of conditions. A fixed lens system, however, may have certain limitations. For example, a fixed lens system may not be well suited to capture macroscopic or wide angle images. Consistent with embodiments disclosed herein, the case 100 may include a camera lens system 104. In some embodiments, the camera lens system 104 may comprise interchangeable lenses such that one or more accessory lenses 108 may be selectively attached to the case 100. In certain embodiments, the one or more accessory lenses 108 may provide enhanced imaging capabilities over a conventional image capturing system integrated in the PED.

Each of the one or more accessory lens 108 comprises a camera lens and/or an optical filter. In some embodiments, the one or more accessory lenses 108 may comprise at least one camera lens, such as an image stabilizing lens, a telephoto lens, a macroscopic lens, a zoom lens, a prime lens, a wide-angle lens, a fisheye lens, a retrofocus lens, an auto-focusing lens, an apochromat lens, a process lens, a refractive lens, a diffractive lens, a stereoscopic lens, a soft focus lens, a swivel lens, a perspective control lens, an infrared lens, an ultraviolet lens, and/or any other type of optical system configured to enhance and/or alter images captured by the PED image capturing system. In some embodiments, the one or more accessory lenses 108 may comprise one or more optical filters including, for example, polarization filters, ultraviolet filters, infrared filters, neutral density filters, clear filters, color filters, color correction filters, color conversion filters, color separation filters, diffusion filters, soft focus filters, cross screen filters, close-up filters, dichroic filters, longpass filters, shortpass filters, antireflective filters, and/or any other optical filter.

As illustrated, the one or more accessory lenses 108 may be attached to the case 100 over the opening 110 exposing the PED image capturing system. In certain embodiments, the one or more accessory lenses 108 may be removably attached to the case 100 via an attachment mechanism 106 integrated into the case 100 and/or the one or more accessory lenses 108. The attachment mechanism 106 may comprise any mechanism configured to allow the one or more accessory lenses 108 to be attached to the case 100. The attachment mechanism 106 is configured to secure an interchangeable lens to the case 100, wherein, when attached, an accessory lens 108 is positioned adjacent to the opening 110 such that light passes through the accessory lens 108 before reaching the image capturing system of the PED. In some embodiments, the attachment mechanism may comprise a mechanism or feature to allow the one or more accessory lenses 108 to be selectively attached and removed from the case 100. For example, the one or more accessory lenses 108 may be attached to the case 100 via one or more protrusions, such as a boss as shown, on the lens that is configured to engage a recessed channel formed within the case 100, as illustrated in FIG. 1. In certain embodiments, the one or more protrusions comprise one or more detents, e.g., ball detents, or pins attached to springs and that engage the recessed channel to attach an accessory lens 108 to the case 100. Alternatively, the attachment mechanism may comprise a compression or snap-fit mechanism integrated into the case 100 and/or the one or more accessory lenses 108. In certain embodiments, the one or more accessory lenses 108 may be attached to the case 100 by pressing the one or more accessory lenses 108 into the case 100, thereby engaging the attachment mechanism 106. Similarly, the one or more accessory lenses 108 may be removed from the case 100 by pulling the one or more accessory lenses 108 from the case 100 and/or twisting the lens with respect to the case, thereby disengaging the attachment mechanism. In some embodiments, the opening 110 may be covered by a protective cover (not shown) configured to protect the image capturing system of the PED when no accessory lens 108 is attached.

In certain embodiments, the attachment mechanism 106 may comprise a guide mechanism configured to align the one or more lens to a particular orientation with respect to the image capture system of the PED. In some embodiments, the guide mechanism restricts an accessory lens 108 to a specific orientation relative to the image capture system. In some embodiments, the guide mechanism prevents an accessory lens 108 from rotating with respect to the case once the accessory lens is attached to the case 100. The guide mechanism comprises one or more guide or stop features and may be disposed on the case 100, on the one or more lenses 108, or on both the case 100 and on the lenses 108. For example, the attachment mechanism 106 may comprise a guide groove included on the case 100 that corresponds to a guide protrusion on a lens 108 such that when the lens 108 is attached to the case 100, the guide groove and protrusion allowing only a single orientation of the lens 108, thus ensuring the lens 108 is properly aligned with respect to the image capture system of the PED. As another example, a lens 108 may include one or more guide pins that insert into one or more corresponding guide holes included on the case 100, wherein the guide pin(s) insert into the guide hole(s) only when the lens 108 is properly aligned with respect to the image capture system of the PED.

In certain embodiments, a particular accessory lens 108 may require electrical power to function (e.g., an auto-focusing lens). In such embodiments, the case 100 may comprise a power source (e.g., a battery) configured to deliver power to the accessory lens 108 via the attachment mechanism 106. Alternatively, or additionally, the case 100 may comprise one or more electrical contacts configured to receive power from the PED (e.g., from a battery in the PED) and deliver the power to the accessory lens 108 via the attachment mechanism 106.

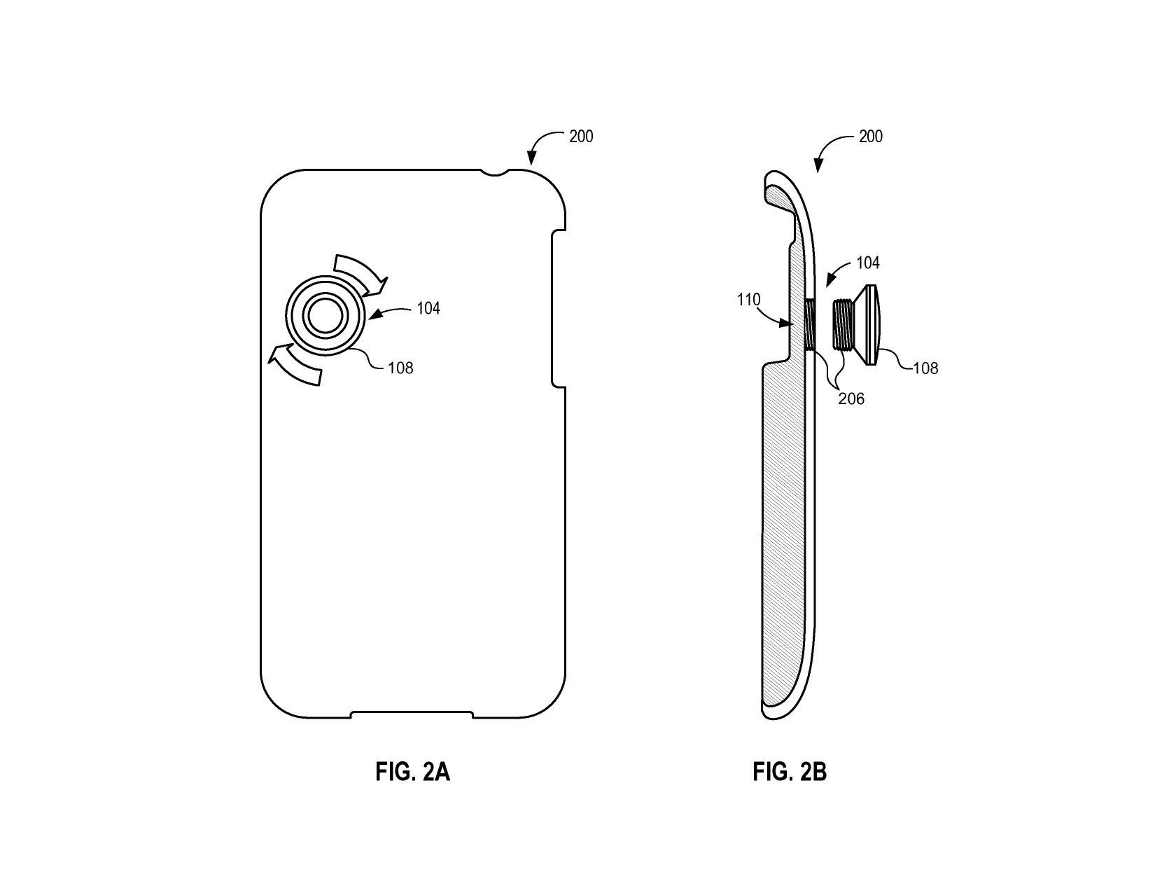

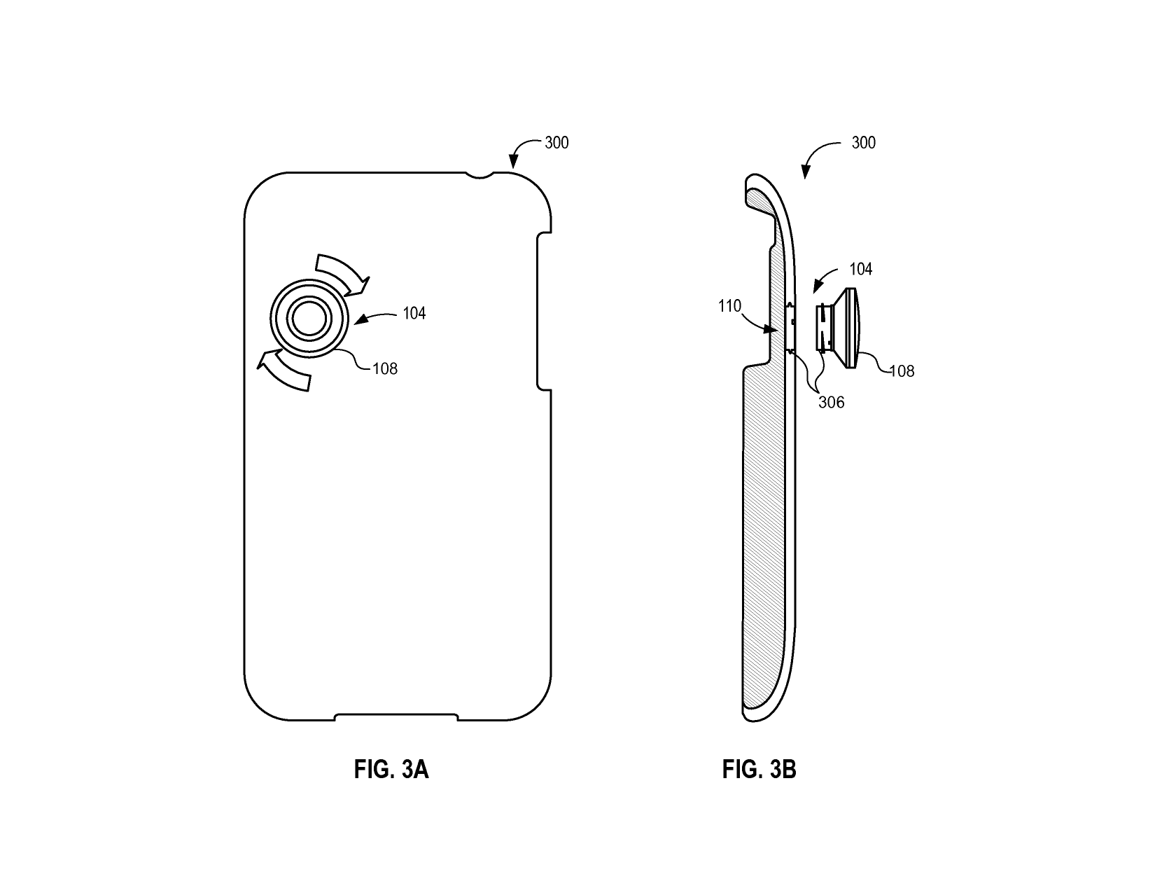

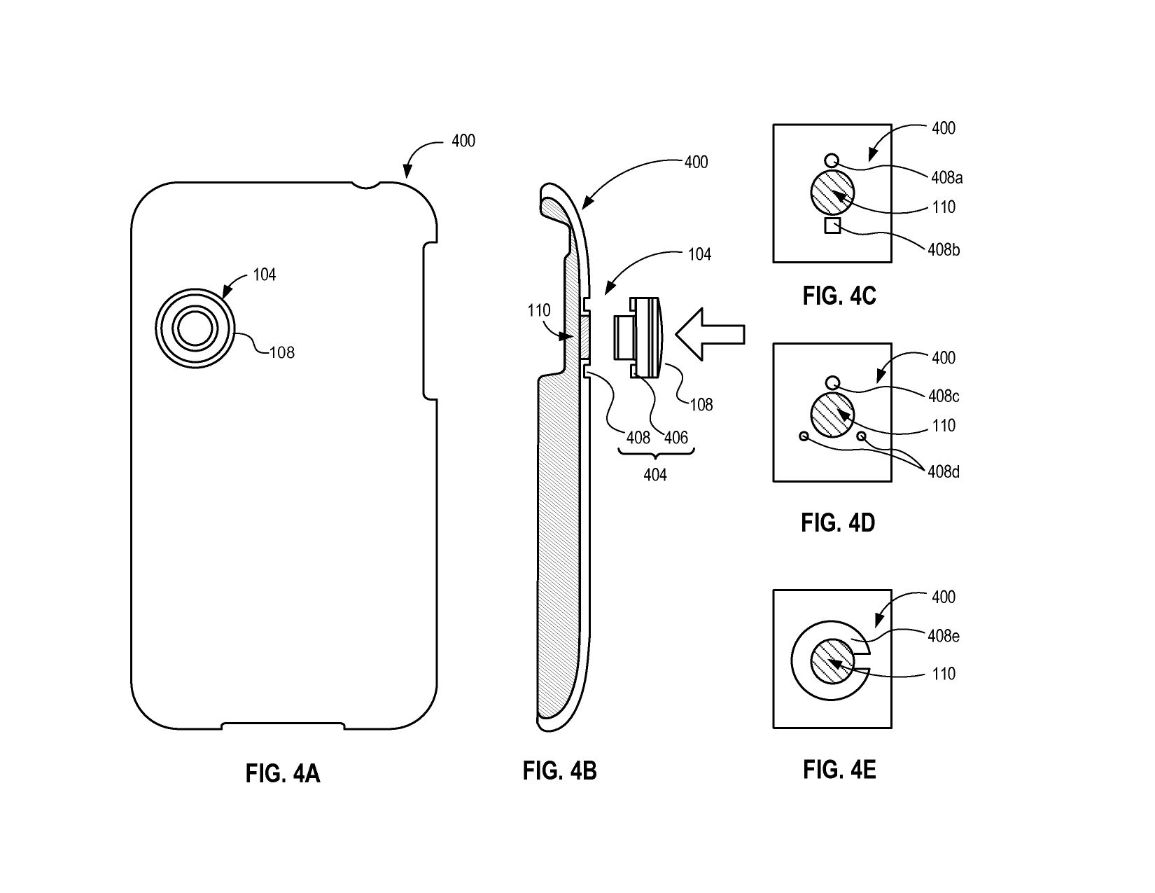

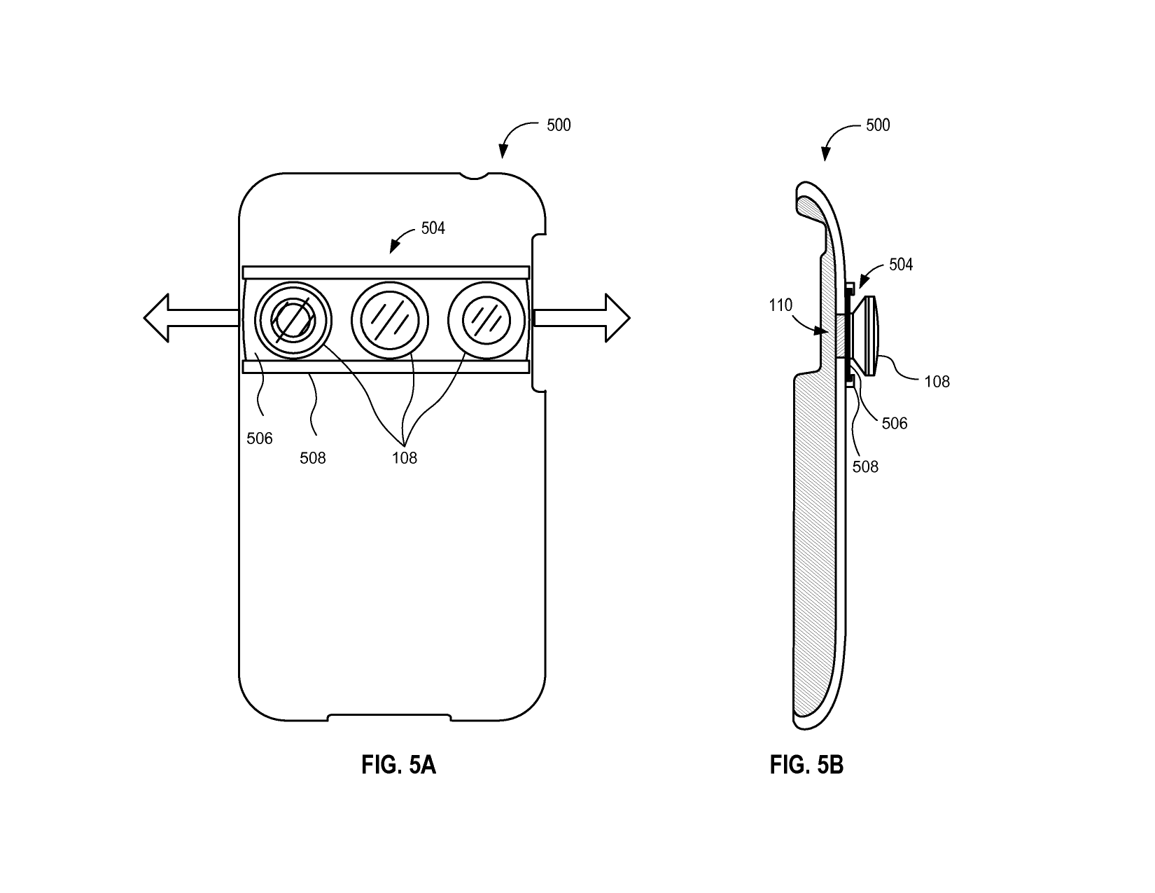

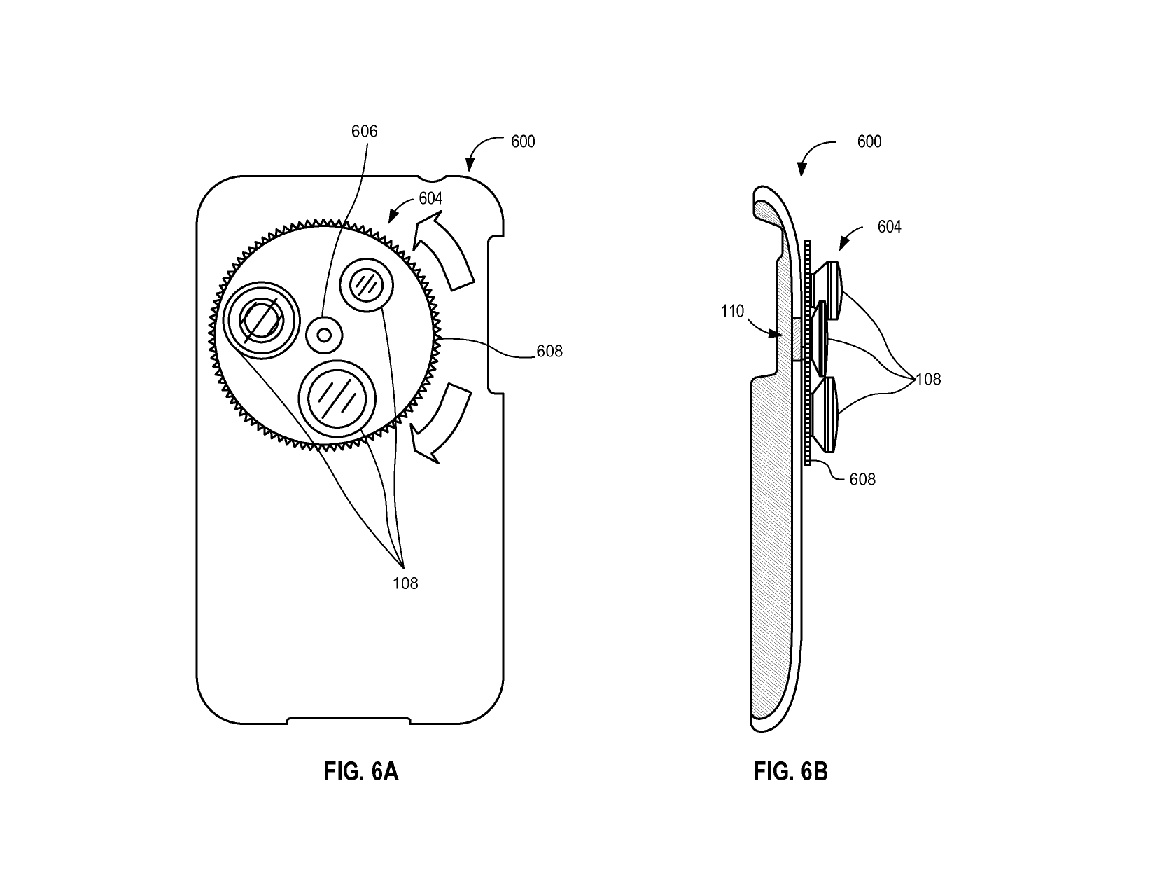

As another example of an attachment mechanism, the case and/or one or more of the lenses may be configured to attach with a magnet. Other examples of means for attaching one or more lenses to a case include adhesives, clips, snaps, clamps, latches, hook-and-loop fasteners, bolts, screws, rivets, retaining rings, retaining pins, spring-actuated levers paired with a notches or grooves, quick-release mechanisms, or buttons. Some of the examples of means for attaching a lens to a case are examples of means for selectively attaching a lens to a case, including the boss and recessed channel example of FIG. 1, the threaded mechanism of FIGS. 2A and 2B, the bayonet mechanism of FIGS. 3A and 3B, the magnetic mechanism of FIGS. 4A and 4B, the sliding mechanism of FIGS. 5A and 5B, and the rotating mechanism of FIGS. 6A and 6B, as discussed below, and other embodiments described above, including clips, snaps, clamps, hook-and-loop fasteners, retaining rings, and buttons.

FIG. 2A and FIG. 2B respectively illustrate a back and a cross-sectional side view of a case accessory 200 for a PED that includes an interchangeable camera lens system 104 utilizing a threaded mechanism 206 consistent with embodiments of the present disclosure. The illustrated case 200 may be similar to the case 100 discussed above in reference to FIG. 1A and FIG. 1B. In the illustrated embodiments, the attachment mechanism may comprise a threaded mechanism 206 integrated into the case 200 and/or the one or more accessory lenses 108. The threaded mechanism 206 is configured to secure an accessory lens 108 to the case 100, wherein, when attached, the accessory lens 108 is positioned adjacent to the opening 110 such that light passes through the accessory lens 108 before reaching the image capturing system of the PED. In certain embodiments, the one or more accessory lenses 108 may be attached to the case 200 by screwing an integrated threaded component included in the one or more accessory lenses 108 into a matched threaded component included in the case 200, thereby engaging the threaded mechanism 206 and securing the one or more accessory lenses 108 to the case 200. Similarly, the one or more accessory lenses 108 may be removed from the case 200 by unscrewing the threaded component included on the one or more accessory lenses 108 from the matched threaded component from the case 200, thereby disengaging the threaded mechanism 206.

In certain embodiments, the threaded mechanism 206 may comprise a guide mechanism configured to align the one or more lens to a particular orientation with respect to the image capture system of the PED. In some embodiments, the guide mechanism restricts an attached accessory lens 108 to a specific orientation relative to the image capture system. In some embodiments, the guide mechanism prevents an accessory lens 108 from rotating with respect to the case once the accessory lens is attached to the case 200. The guide mechanism may comprise one or more guide or stop features and may be disposed on the case 200, on the one or more lenses 108, or on both the case 200 and on the lenses 108. For example, the threaded mechanism 206 may comprise a thread stop feature included with the matched threaded component on the case 200 that defines the maximum depth by which a lens 108 may be screwed into the case 200 such that when the lens 108 is screwed to the maximum depth it is properly aligned with respect to the image capture system of the PED.

FIG. 3A and FIG. 3B respectively illustrate a back and a cross-sectional side view of a accessory case 300 for a PED that includes an interchangeable camera lens system 104 utilizing a bayonet mount mechanism 306 consistent with embodiments of the present disclosure. The illustrated case 300 may be similar to the cases 100, 200 discussed above in reference to FIGS. 1A-1B and 2A-2B. In the illustrated embodiments, the attachment mechanism may comprise a bayonet mechanism 306 integrated into the case 300 and/or the one or more accessory lenses 108. The bayonet mechanism 306 may comprise any suitable type of lens mount or friction fit bayonet-type mount. The bayonet mechanism 306 is configured to secure an accessory lens 108 to the case 100, wherein, when attached, the accessory lens 108 is positioned adjacent to the opening 110 such that light passes through the accessory lens 108 before reaching the image capturing system of the PED. In certain embodiments, the one or more accessory lenses 108 may be attached to the case 300 by screwing a male or female component included on the one or more accessory lenses 108 into a matched male or female component included in the case 300, thereby engaging the bayonet mechanism 306 and securing the one or more accessory lenses 108 to the case 300. Similarly, the one or more accessory lenses 108 may be removed from the case 300 by unscrewing the male or female component included on the one or more accessory lenses 108 from the matched male or female component from the case 300, thereby disengaging the bayonet mechanism 306.

In certain embodiments, the bayonet mechanism 306 may comprise a guide mechanism configured to align the one or more lens to a particular orientation with respect to the image capture system of the PED. In some embodiments, the guide mechanism restricts an attached accessory lens 108 to a specific orientation relative to the image capture system. In some embodiments, the guide mechanism prevents an accessory lens 108 from rotating with respect to the case once the accessory lens is attached to the case 300. The guide mechanism comprises one or more guide or stop features and may be disposed on the case 300, on the one or more lenses 108, or on both the case 300 and on the lenses 108. For example, the bayonet mechanism 306 may comprise a stop feature included with the matched male or female component on the case 300 that defines a maximum rotation by which a lens 108 may be rotated when screwing into the case 300 such that when the lens 108 is screwed to the maximum it is properly aligned with respect to the image capture system of the PED.

FIG. 4A and FIG. 4B respectively illustrate a back and a cross-sectional side view of a accessory case 400 for a PED that includes an interchangeable camera lens system 104 utilizing a magnetic mechanism 404 consistent with embodiments of the present disclosure. The illustrated case 400 may be similar to the cases 100, 200, 300 discussed above in reference to FIGS. 1A-1B, 2A-2B, and 3A-3B. In the illustrated embodiments, the attachment mechanism may comprise a magnetic mechanism 404 integrated into the case 400 and the one or more accessory lenses 108. The magnetic mechanism 404 is configured to secure an accessory lens 108 to the case 100, wherein, when attached, the accessory lens 108 is positioned adjacent to the opening 110 such that light passes through the accessory lens 108 before reaching the image capturing system of the PED. The magnetic mechanism 404 may comprise any suitable combination of magnetic material and magnetically attracted material disposed on the case 400 and the one or more accessory lenses 108. For example, the case 400 may be configured with a corresponding ferromagnetic plate or similar feature such that the magnets on the lenses 108 may be attached to the ferromagnetic feature on the case 400. As another example, the case 400 may be configured with one or more magnets, and the one or more lenses 108 may be configured with a ferromagnetic feature such that a given lens 108 can be attached to the case 400. As yet another example, both the case 400 and the one or more lenses 108 may be configured with magnets such that the lenses 108 may be selectively attached to the case 400.

In certain embodiments, the magnetic mechanism 404 may comprise a guide mechanism configured to align the one or more lens to a particular orientation with respect to the image capture system of the PED. In some embodiments, the guide mechanism restricts an accessory lens 108 to a specific orientation relative to the image capture system. In some embodiments, the guide mechanism prevents an accessory lens 108 from rotating with respect to the case once the accessory lens is attached to the case 400. The guide mechanism comprises one or more guide or stop features and may be disposed on the case 400, on the one or more lenses 108, or on both the case 400 and on the lenses 108. For example, the magnetic mechanism 404 may comprise a guide groove included on the case 400 that corresponds to a guide protrusion on a lens 108 such that when the lens 108 is attached to the case 400, the groove and protrusion allow only a single orientation of the lens 108, thus ensuring the lens 108 is properly aligned with respect to the image capture system of the PED. As another example, the magnetic mechanism 404 may comprise magnets on both the case 400 and a lens 108, said magnets having polarization selected so that the magnets on the lens 108 are attracted to the magnets on the case 400 only when the lens is properly aligned with respect to the image capture system of the PED. Specifically, a pair of magnets oriented to opposite polarities may be disposed near the opening 110 on the case 400 such that corresponding magnets on an accessory lens 108 will be attracted when properly aligned and repulsed when improperly aligned.

In certain embodiments, the magnetic mechanism 404 comprises one or more magnetic tabs 406 disposed on the lenses 108 and one or more corresponding magnetic receivers 408 disposed on the case 400. The magnetic tabs 406 and receivers 408 allow the lenses 108 to be mounted more securely to the case 400 and may also ensure that each lens 108 is properly oriented to the image capturing system on the PED. Each magnetic tab 406 may comprise a protrusion or similar feature on a given lens 108 that is magnetic (or magnetically attractive) and that is sized, shaped, and/or dimensioned to fit into a corresponding magnetic receiver 408. Each magnetic receiver 408 may comprise a recess or similar feature formed into the case 400 that is magnetic (or magnetically attractive) and that is sized, shaped, and/or dimensioned to receive a corresponding magnetic tab 406. In some embodiments, the magnetic tab 406 and the magnetic receiver 408 fit together snugly such that a given lens 108 is secured to the case 400 both by magnetic attraction and by a friction fit. In certain embodiments, the magnetic receiver is shaped to allow an accessory lens 108 to attach to the case 400 only at a specific orientation relative to the camera of the PED, thus becoming both a guide mechanism and a magnetic attachment mechanism. While the embodiment of FIG. 4B shows magnetic tabs 406 on the lens 108 and magnetic receivers 408 on the case 400, it some embodiments the magnetic tabs 406 may be on the case 400 while the magnetic receivers 408 may be on the lens 108.

The one or more accessory lenses 108 may be attached to the case 400 by aligning the magnetic (or magnetically attracted) feature (e.g., magnetic tab 406) included on the one or more accessory lenses 108 with a matched feature (e.g., magnetic receiver 408) included in the case 400 and bringing the aligned features into proximity, thereby securing the one or more accessory lenses 108 to the case 400 via magnetic attraction. The one or more accessory lenses 108 may be removed from the case 400 by pulling the one or more accessory lenses 108 away from the case 400, thereby disengaging the magnetic mount system 404.

FIGS. 4C-4E are back views of accessory case 400 and illustrate different arrangements of magnetic receivers 408. FIG. 4C illustrates one embodiment of a magnetic receiver 408 comprising a circular receiver 408a and a square receiver 408b. A circular and a square magnetic tab 406 included on the lens 108 correspond to the circular receiver 408a and the square receiver 408b, respectively. The different shapes comprise a guide mechanism allowing the lens 108 to attach to the case 400 in only a specific orientation, thereby ensuring that the lens 108 is properly oriented to the image capturing system on the PED. FIG. 4D illustrates another embodiment of a magnetic receiver 408 comprising a larger receiver 408c and two smaller receivers 408d. A trio of appropriately sized magnetic tabs 406 included on the lens 108 correspond to the larger receiver 408c and two smaller receivers 408d, respectively. The illustrated arrangement comprises a guide mechanism allowing the lens 108 to attach to the case 400 in only a specific orientation, thereby ensuring that the lens 108 is properly oriented to the image capturing system on the PED. FIG. 4E illustrates another embodiment of a magnetic receiver 408 comprising a “C”-shaped receiver 408e. A “C”-shaped magnetic tab 406 included on the lens 108 corresponds to the “C”-shaped magnetic receiver 408e. The “C”-shaped receiver 408e comprises a guide mechanism allowing the lens 108 to attach to the case 400 in only a specific orientation, thereby ensuring that the lens 108 is properly oriented to the image capturing system on the PED.

FIG. 5A and FIG. 5B respectively illustrate a back and a cross-sectional side view of a case accessory 500 for a PED that includes an interchangeable camera lens system 504 utilizing a sliding mechanism consistent with embodiments of the present disclosure. The illustrated case 500 may be similar to the cases 100, 200, 300, 500 discussed above in reference to FIGS. 1A-1B, 2A-2B, 3A-3B, and 4A-4B. The illustrated case 500 may include an integrated interchangeable camera lens system 504 that comprises one or more accessory lenses 108. The one or more accessory lenses 108 may be mounted on a sliding mount 506 secured in part by one or more guides 508 disposed on a surface of the case 500. The sliding mount 506 and one or more guides 508 may be disposed horizontally, laterally, or in any other suitable configuration on the surface of the case 500.

In certain embodiments, the sliding mount 506 may be configured to slide or otherwise move relative to the case 500 within a channel defined by the one or more guides 508, thereby enabling the one or more accessory lenses 108 to be variably positioned over an opening 110 in the case 500 to utilize one or more of the lenses in connection with an image capturing system included on a PED such that light passes through the accessory lens 108 before reaching the image capturing system of the PED. For example, if a user wishes to use a telephoto lens of the accessory lenses 108, the user may position the sliding mount 506 such that the telephoto lens is positioned over the opening 110 in the case 500.

In some embodiments, the sliding mount 506 and/or the guides 508 may include a mechanism configured to enable the sliding mount 506 to “snap” into one or more predefined positions relative to the case 500. In certain embodiments, this mechanism is configured to bias the sliding mount 506 to the one or more predefined positions. In certain embodiments, this mechanism is configured to restrict further movement by the sliding mount 506 after reaching the one or more predefined positions. In certain embodiments, moving the sliding mount 506 from the one or more predefined positions may require more force than moving the sliding mount 506 between the one or more predefined positions. In certain embodiments, the sliding mount 506 may include one or more tabs, detents, and/or other similar structures configured to enable a user to more easily move the sliding mount 506 within the channel defined by the one or more guides 508. In some embodiments, the sliding mount 506 may be moved into a position where neither the sliding mount 506 nor any of the accessory lenses 108 obstruct the opening 110 of the case 500 exposing the PED image capturing system. For example, in some embodiments, the sliding mount 506 and/or another component of the camera lens system 504 may be configured to slide or otherwise move in a direction along the length of the PED (perpendicular to the arrows shown in FIG. 5A). In further embodiments, the sliding mount 506 may be moved to a position that protects the PED image capturing system from external damage (e.g., in a storage mode).

FIG. 6A and FIG. 6B respectively illustrate a back and a cross-sectional side view of a case accessory 600 for a PED that includes an interchangeable camera lens system 604 utilizing a rotating mechanism consistent with embodiments of the present disclosure. The illustrated case 600 may be similar to the cases 100, 200, 300, 500, 500 discussed above in reference to FIGS. 1A-1B, 2A-2B, 3A-3B, 4A-4B, and 5A-5B. The illustrated case 600 may include an integrated interchangeable camera lens system 604 that comprises one or more accessory lenses 108. The one or more accessory lenses 108 may be mounted on a rotating mount 608 secured about a fixed pivot 606 disposed on the surface of the case 600. In certain embodiments, the rotating mount 608 may be configured to rotate relative to the case 600 about the fixed pivot 606, thereby enabling the one or more accessory lenses 108 to be variably positioned over an opening 110 in the case 600 exposing an image capturing system included on a PED such that light passes through the accessory lens 108 before reaching the image capturing system of the PED. For example, if a user wishes to use a telephoto lens of the accessory lenses 108, the user may position (i.e., rotate) the rotating mount 608 such that the telephoto lens of the accessory lenses 108 is positioned over the opening 110 in the case 600 exposing the PED image capturing system.

In some embodiments, the rotating mount 608 and/or the fixed pivot 606 may include a mechanism configured to enable the rotating mount 608 to “snap” into one or more predefined positions relative to the case 600. In certain embodiments, this mechanism is configured to bias the rotating mount 608 to the one or more predefined positions. In certain embodiments, this mechanism is configured to restrict further movement by the rotating mount 608 after reaching the one or more predefined positions. In certain embodiments, moving the rotating mount 608 from the one or more predefined positions may require more force than moving the rotating mount 608 between the one or more predefined positions. In certain embodiments, the rotating mount 608 may include one or more tabs, detents, and/or other similar structures configured to enable a user to more easily articulate the rotating mount 608 about the fixed pivot 606. In some embodiments, the rotating mount 608 may be moved to a position where neither the rotating mount 608 nor any of the accessory lenses 108 obstruct the opening 110 of the case 600 exposing the PED image capturing system. For example, in some embodiments, one of the predefined positions of the rotating mount 608 may include an opening without a lens. In other embodiments, the rotating mount 608 itself may be moveable to a position away from the opening 110. In some embodiments, the rotating mount 608 may be articulated in a position that protects the PED image capturing system from external damage (e.g., in a storage mode).

In some embodiments, the fixed pivot 606 comprises an attachment mechanism to which the rotating mount 608 may be detachably secured. The detachable rotating mount 608 allows for a plurality of rotating mounts 608 to be used in the integrated interchangeable camera lens system 604. Additionally, the detachable rotating mount 608 may be removed from the case 400 and stored separately when not in use.

It will be understood by those having skill in the art that changes may be made to the details of the above-described embodiments without departing from the underlying principles presented herein. For example, the interchangeable lens systems disclosed herein may be integrated into a stand, a mount, or any other type of accessory configured to receive a PED. In addition, any suitable combination of various embodiments, or the features thereof, is contemplated.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

It will be obvious to those having skill in the art that many changes may be made to the details of the above-described embodiments without departing from the underlying principles of the invention. The scope of the present invention should, therefore, be determined only by the following claims.

1. An accessory case for a portable electronic device (PED) comprising:
an opening configured to expose an image capturing system included on the PED;
one or more interchangeable lenses configured to alter the performance of the PED image capturing system; and
an attachment mechanism configured to secure an interchangeable lens to the accessory case, wherein, when attached, the interchangeable lens is positioned adjacent to the opening such that light passes through the interchangeable lens before reaching the image capturing system of the PED,
wherein the attachment mechanism comprises a guide mechanism configured to restrict an attached interchangeable lens to a specific orientation relative to the image capturing system.

2. The accessory case of claim 1, wherein the attachment mechanism comprises a recessed channel and wherein each of the one or more interchangeable lenses comprises one or more protrusions configured to engage the recessed channel to secure the interchangeable lens to the accessory case.

3. The accessory case of claim 2, wherein the one or more protrusions each comprise a detent attached to a spring and configured to engage the recessed channel to secure the interchangeable lens to the accessory case.

4. The accessory case of claim 2, wherein the guide mechanism comprises a guide protrusion configured to engage a corresponding guide groove in an interchangeable lens and wherein each of the one or more interchangeable lenses comprises a guide groove configured to receive the guide protrusion so that the interchangeable lens can only attach to the accessory case at the specific orientation relative to the image capturing system.

5. The accessory case of claim 1, wherein the attachment mechanism comprises one or more magnetic receivers configured to be attracted to a magnet and to receive a corresponding magnetic protrusion, and wherein each of the one or more interchangeable lenses comprises one or more magnetic protrusions which correspond to the one or more magnetic receivers and are configured to magnetically attract the one or more magnetic receivers to secure the interchangeable lens to the accessory case.

6. The accessory case of claim 5, wherein the guide mechanism comprises a magnetic receiver shaped to allow an interchangeable lens to attach to the accessory case only at the specific orientation relative to the image capturing system.

7. The accessory case of claim 5, wherein the one or more magnetic receivers comprise magnets, and wherein the guide mechanism comprises a selection of magnetic polarities on the one or more magnetic receivers magnetic that allows an interchangeable lens to attach to the accessory case only at the specific orientation relative to the image capturing system.

8. The accessory case of claim 1, wherein the attachment mechanism comprises a threaded attachment mechanism and wherein each of the one or more interchangeable lenses comprise a threaded portion configured to engage the threaded attachment mechanism to secure the interchangeable lens to the accessory case.

9. The accessory case of claim 9, wherein the guide mechanism comprises a thread stop on the threaded attachment mechanism configured to prevent further screwing of an interchangeable lens after the interchangeable lens is screwed in a maximum distance, wherein the thread stop causes the interchangeable lens to stop at the specific orientation relative to the image capturing system.

10. A case for a portable electronic device (PED) comprising:
an opening configured to allow a camera system of the PED to capture an image exterior to the case;
an accessory lens comprising one or more attachment protrusions and configured for use with the camera system of the PED; and
an integrated attachment mechanism for securing the accessory lens to the case in a certain position relative to the camera system of the PED, wherein the integrated attachment mechanism comprises:
a recessed channel configured to engage the one or more attachment protrusions to secure the accessory lens to the accessory case, and
a guide mechanism configured to restrict the accessory lens from rotating with respect to the camera system when attached to the case, wherein when the accessory lens is attached to the case it is positioned adjacent to the opening such that light passes through the accessory lens before reaching the camera system of the PED.

11. The case of claim 10, wherein the guide mechanism comprises a guide protrusion configured to engage a corresponding guide groove in the accessory lens and wherein the accessory lens comprises a guide groove configured to receive the guide protrusion so that the interchangeable lens can only attach to the accessory case at the specific orientation relative to the image capturing system.

12. The case of claim 10, wherein at least one accessory lens comprises one of: an image stabilizing lens, a telephoto lens, a zoom lens, a macroscopic lens, a wide angle lens, a fisheye lens, or an auto-focusing lens.

13. The case of claim 10, wherein at least one accessory lens comprises one of: a polarization filter, an ultraviolet filter, an infrared filter, a neutral density filter, a color filter, or an antireflective filter.

14. A case for a portable electronic device (PED) comprising:
an opening configured to allow a camera system of the PED to capture an image exterior to the case;
an accessory lens comprising one or more magnetic protrusion and configured for use with the camera system of the PED; and
an integrated attachment mechanism securing an accessory lens to the case in a specific position relative to the camera system of the PED, the integrated attachment mechanism comprising:
one or more magnetic receivers configured to receive the one or more magnetic protrusions to secure the accessory lens; and
a guide mechanism configured to restrict the attached accessory lens from rotating with respect to the camera system,
wherein, when the accessory lens is attached to the case, it is positioned adjacent to the opening such that light passes through the accessory lens before reaching the camera system of the PED.

15. The case of claim 14, wherein the guide mechanism comprises a guide protrusion configured to engage a corresponding guide groove in the accessory lens and wherein the accessory lens comprises a guide groove configured to receive the guide protrusion so that the accessory lens attaches to the accessory case only at a specific orientation relative to the camera system.

16. The case of claim 14, wherein the one or more magnetic receivers comprise two magnets, wherein the one or more magnetic protrusions comprise two magnets corresponding to the recessed magnets, and wherein the recessed magnets have opposite magnetic polarities so that the accessory lens attaches to the accessory case only at a specific orientation relative to the camera system.

17. The case of claim 14, wherein the guide mechanism comprises a magnetic receiver shaped to allow an interchangeable lens to attach to the accessory case only at a specific orientation relative to the camera system.

18. The case of claim 14, wherein the accessory lens comprises one of: an image stabilizing lens, a telephoto lens, a zoom lens, a macroscopic lens, a wide angle lens, a fisheye lens, or an auto-focusing lens.

19. The case of claim 14, wherein the accessory lens comprises one of: a polarization filter, an ultraviolet filter, an infrared filter, a neutral density filter, a color filter, or an antireflective filter.
